(19) United States
(12) Patent Application Publication
(10) Pub. No.: US 2018/0017381 A1
(43) Pub. Date: Jan. 18, 2018

(54) POSITIONING OF TWO BODIES BY MEANS OF AN ALIGNMENT SYSTEM WITH A PAIR OF DATA SPECTACLES

(71) Applicant: Prüftechnik Dieter Busch AG, Ismaning (DE)

(72) Inventors: Roland Hölzl, München (DE); Holger Schmidt, Unterföhring (DE)

(73) Assignee: Prüftechnik Dieter Busch AG, Ismaning (DE)

(21) Appl. No.: 15/546,084

(22) PCT Filed: Dec. 28, 2015
(86) PCT No.: PCT/DE2015/200541

§ 371 Date: Jul. 25, 2017

(30) Foreign Application Priority Data
Jan. 26, 2015 (DE) 10 2015 201 290.5

(51) Int. Cl. G01B 11/27; G06T 7/60; G01C 9/02; H04N 5/232; H04N 5/225; G02B 27/01

(52) U.S. Cl. CPC G01B 11/272; H04N 5/23293; H04N 5/2256; G06T 7/60; G01C 9/02; G06T 7/74; G02B 2027/0141; G02B 27/0101; G06T 2207/30204

(57) ABSTRACT

A method for bringing two bodies (1, 2, 6, 7) into predetermined positions with respect to one another, which is carried out by an alignment system having data spectacles (smart glasses) (12). The dimensions of the bodies (1, 2 , 6, 7) and/or respective positions of the bodies (1, 2, 6, 7) are determined relative to each other by a data processing means (17) of the data spectacles (12) on the basis of images which are detected by an image detection means (16) of the data spectacles (12). Furthermore, an adjustment value is displayed in a display device 18 of the data spectacles (12).

### BACKGROUND OF THE INVENTION

### Field of the Invention

The present invention relates to a method for bringing two bodies into prescribed positions relative to one another and to an orientation system for performing such a method having at least one light emission apparatus for emitting a light beam and at least one light sensing apparatus that has a light-sensitive area, wherein an impingement position for a light beam emitted by the light emission apparatus on the light-sensitive area is registrable.

### Description of Related Art

In numerous technical fields, there is the need for bodies to be arranged at prescribed positions relative to one another as exactly as possible. Thus, it may be necessary for axes of rotation of two rotatably mounted machine parts to be oriented in alignment as precisely as possible. This involves the spatial and/or angular positions of the two machine parts relative to one another being determined and adjusted accordingly until the axes of rotation thereof are in alignment with one another. An orientation system provided for this purpose and having a light emission apparatus for emitting a light beam and a light sensing apparatus that has a light-sensitive area, wherein an impingement position for a light beam emitted by the light emission apparatus on the light-sensitive area is registrable, is known from German Utility Model DE 20 2009 017 510 U1 , for example.

Further, International Patent Application Publication WO 01/35178 A1 and corresponding U.S. Pat. No. 7,103,506 disclose a system having a pair of data goggles that can be used to sense a specific work situation for an installation that is to be serviced. On the basis of the sensed work situation, an apparatus connected to the data goggles via a bidirectional data link can make a selection from data about the serviced installation. These data can be displayed to a user of the data goggles, with the real work situation being expanded by the ascertained data or information in the field of view of the user. A similar system is also disclosed in International Patent Application Publication WO 00/52537 A1 and corresponding U.S. Pat. Nos. 6,941,248; 7,324,081 and 8,373,618.

International Patent Application Publication WO 03/050626 A1 and corresponding U.S. Pat. No. 7,110,909 disclose the use of a corresponding system for creating documentation for work processes for depiction in an augmented reality system. The system has particularly tracking means for determining the position and orientation of a camera relative to points in space and also a mobile computer for processing the image information recorded by the camera and the position and orientation of the camera and for forwarding the processed image information as image data and the position and orientation of the camera as tracking information to a remote computer system. International Patent Application Publication WO 00/58799 A1 and corresponding U.S. Pat. No. 7,814,122 also discloses a comparable system for processing documentation particularly for technical and industrial applications.

By contrast, European Patent Application Publication EP 2 523 061 A1 amd corresponding U.S. Pat. No. 8,686,871 disclose a monitoring system having a pair of data goggles that is provided for monitoring machines. The data goggles have a sensor for sensing the presence of an installation within a prescribed distance from the data goggles.

German Patent Application Publication DE 199 42 586 A1 relates to a method and an arrangement for preparing a crash experiment with a motor vehicle, for which individual parts of a crash test dummy in a motor vehicle are positioned at stipulated reference locations within the passenger compartment. In a freely movable pair of data goggles for a person responsible for preparing the experiment, the setpoint position of the crash test dummy is mirrored into the field of vision of the person responsible for preparing the experiment, with the current position of the data goggles relative to the motor vehicle being determined by a measurement.

### SUMMARY OF THE INVENTION

Against this background, it is the object of the present invention to provide a method and an orientation system that can be used to bring two bodies into prescribed positions relative to one another quickly, exactly and conveniently.

This object is achieved by the method and by the orientation system having the features described herein.

The subject matter of the present application substantially simplifies the process of bringing two bodies, which may preferably be machines or machine parts, into prescribed positions relative to one another. Thus, the mere ascertainment of dimensions of the bodies and of respective positions of the bodies relative to one another, knowledge of which is required for positioning, since the measurement data are processed by inclusion thereof or on the basis thereof, is simplified in comparison with conventional methods by virtue of these data being able to be determined on the basis of images that are captured or recorded from the bodies or parts thereof using the image capture means of the data goggles smart glasses, instead of ascertaining these data by means of specific measurement of the bodies, as in the case of known methods, and laboriously inputting the resultant measured values or values read from a database or table into a handheld device or an orientation computer.

In general, the invention allows such a handheld device or orientation computer to be dispensed with completely, since the measurement data, which correspond to registered impingement positions for the light beam emitted by the light emission apparatus on the light-sensitive area of the light sensing apparatus, are transmitted directly to the data goggles, processed therein by the data processing means thereof, which can have at least one processor or which may be a miniature computer or minicomputer, and adjustment values produced therefrom are displayed on the display means of the data goggles. Since a standard handheld device or orientation computer usually weighs approximately 1 kg and, during the orientation process, has to be alternately operated, and in that case held in the hand, and repeatedly put down and picked up again for adjustment purposes, which means that a user, such as a servicing person, can easily lose sight of a display of the device, which can display important information for the current work process, a positioning method that can be performed without a handheld device or an orientation computer makes a significant contribution to simplifying the positioning process. Particularly during performance of the actual changes of position for the machines, it is important for adjustment that the information required therefor is accessible or visible. Display thereof in the display means of the data goggles as in the case of the present invention entails the advantage over display in a display of a handheld device or orientation computer that this information is always visible, which means that positioning can be performed conveniently and effectively. This can involve advice, warnings and alarms being output to the servicing person visually via the display means or, if the orientation system and particularly the data goggles have loudspeakers, audibly. Feedback by the servicing person can be provided in arbitrary fashion in this case, for example, by voice, touch, blinking and eye or head movements.

In this case, the present invention is not restricted to methods and orientation systems for which the light emission apparatus is arranged on a first of the bodies and the light sensing apparatus on the respective second of the bodies. Rather, the invention also comprises methods and orientation systems for which both the light emission apparatus and the light sensing apparatus are situated on the same body, i.e., for which the light emission apparatus and the light sensing apparatus are arranged on the same body, or for which both at least one light emission apparatus and at least one light sensing apparatus are arranged on both bodies. The light emission apparatus and the light sensing apparatus may particularly be integrated in a single module. In cases in which both the light emission apparatus and the light sensing apparatus are arranged on a first of the bodies, the orientation system can additionally have at least one device that is arranged on the respective second body and ensures that light emitted by the light emission apparatus in the direction of the second body is deflected back in the direction of the first body again and impinges on the light-sensitive area of the light sensing apparatus arranged at that location. This device can comprise, by way of example, a reflector, such as a mirror, or another optical means such as lenses or prisms or an optical system having multiple optical means. Quite generally, if required depending on the embodiment of the orientation system or of the light emission apparatus and of the light sensing apparatus, arbitrary optical means such as reflectors, mirrors, lenses or prisms may be provided on each of the bodies, specifically either on both bodies or just on a single one of the two bodies.

If necessary, the data goggles can have further devices, such as an acceleration sensor, particularly a nine-axis sensor, a gyroscope, a compass, an inclinometer, a touchpad, a bone conduction loudspeaker or a USB Universal Serial Bus port, for example. A current source in the form of a battery or of a storage battery may be arranged at the end of a leg of the goggles as a counterbalance for the image capture means and the display means. If an energy source of the data goggles, such as a battery or a storage battery, for example, has inadequate capacity, a supplementary device having additional radio interfaces may be provided that, for example, is wearable on the belt of the servicing person and may be connected to the data goggles via a cable.

For the purpose of transmitting the measurement data to the data goggles, there may be either a cable link or a wireless link or data transmission link or communication link provided between the data goggles and the light emission apparatus and/or the light sensing apparatus, a wireless link being preferred for the data transmission. Therefore, the data transmission link between the data goggles and the light sensing apparatus may be formed directly or indirectly, for example, with a detour via the light emission apparatus. In particular, the wireless data transmission can be effected by means of a WLAN Wireless Local Area Network or Bluetooth link. If there is a wireless network with a low data volume, the data transmission can be effected in accordance with a specification referred to as ZigBee. In some exemplary embodiments, there is provision for control of the light emission apparatus and/or the light sensing apparatus by the data goggles, which for this purpose may be connected, and in particular communicatively connected, not only to the light sensing apparatus but also to the light emission apparatus.

Further, the image capture means, which in the simplest case may be a photographic or movie camera, and particularly a digital camera, can capture one or more images in the line of vision of a wearer of the data goggles by recording said images, so that the recorded images can be stored in a data memory of the data goggles or in an external memory. It is thus possible for the image capture means to be used to capture or record images of, for example, defective parts of machines for logging or documentation purposes. Advantageously, an angle between the image capture means and a frame of the data goggles may be adjustable for the purpose of enlarging the recording area of the image capture means.

The display means may be what is known as a head up display HUD, that is to say a display system in which the wearer of the data goggles can maintain his head posture or line of vision because information is projected into his field of view. This information can be combined with images captured by the image capture means. For the most part, the display means has an internal projector and a prism. Apart from data and information such as numerical values, drawings, plans, graphics, graphs, movies, images or texts that are required for positioning the bodies, the display means can also be used to display other information relevant to further maintenance in a style of augmented reality AR in the display means. For example, a servicing person can be guided in reading in an oil level for machines by displaying appropriate information in the display means, relating to work steps to be performed. In one advantageous embodiment of the invention, when problems arise, it is further possible to use the display means to consult experts by video conference. These experts can use the image capture means to have a look at the situation directly in situ, and if need be they can instruct the wearer of the data goggles where he needs to go and look. Hence, the expert can advise a servicing person directly.

It is also possible for the oil level to be read in, by way of example, using the image capture means, the image capture means being used to capture an image of an inspection glass that the data processing means of the data goggles can take as a basis for determining or calculating a height of the oil level. The determined height value can be stored for documentation purposes in a database.

In one preferred embodiment of the method according to the invention, the bodies are rotatably mounted machine parts of two machines that have respective axes of rotation, wherein the method involves the machine parts being brought into prescribed positions relative to one another in which the axes of rotation are oriented in alignment with one another, wherein the machine parts are rotated synchronously and the light beam impinges on the light-sensitive area at least during part of the rotation. This embodiment substantially simplifies the process of orienting axes of rotation, which are normally identical to longitudinal axes, of rotatably mounted machine parts, such as axles, rollers or shafts, for example, of two machines.

In another preferred embodiment of the method according to the invention, the bodies are machines, wherein at least some steps are carried out during operation of the machines. This embodiment particularly allows the relative positions of two machines to be monitored constantly and in real time during operation thereof, since these positions can change over the course of time as a result of vibrations. If need be, the operation of the machines can be interrupted in order to correct the relative positions of the machines, if the adjustment value exceeds a prescribed limit value.

Dimensions of the bodies and/or respective positions of the bodies relative to one another can be determined in different ways. By way of example, it is thus possible for the capturing of at least one image to be preceded by at least one reference scale being arranged on one of the bodies or adjacently to the bodies that appears in the at least one captured image, the dimensions of the bodies and/or the respective positions of the bodies relative to one another being determined by a comparison of dimensions in the image with the reference scale appearing in the image. If, for example, for reasons of space, it is difficult or not possible to capture the images of the bodies that are required for determining the dimensions and positions, then there may alternatively be provision for the image capture means to be used to capture at least two reference points on the bodies from a prescribed physical position, for a solid angle measurement means of the data goggles to measure respective angles between a reference line and respective connecting lines that connect the respective reference points to the prescribed physical position, and for the measured angles to be used for determining the dimensions of the bodies and/or the respective positions of the bodies relative to one another. For this purpose, the data goggles can have at least one or more solid angle measurement means such as inclinometers, for example. In particular, the inclination can be determined using acceleration sensors, and a gyroscope or compass may be provided for capturing an angle of azimuth. All these sensors may be provided in the data goggles. Alternatively, these sensors may also be arranged in a smartphone.

In one preferred embodiment, the image capture means captures an image of at least one marking put on one of the bodies and this marking is taken as a basis for the data goggles to access stored data. The stored data may be, by way of example, dimensions of the bodies or machines and/or machine parts. Quite generally, the marking may be any character or a code, such as a two-dimensional code in the style of a barcode or a QR quick response code, for example. Such markings may, if the bodies are machines, be put, by way of example, on a foot or multiple feet of one or both machines or on machine parts. Following identification and association of this marking by the data goggles, a servicing person can be provided with precisely the information that he needs for orienting the machine to this foot in the display means of the data goggles. The stored data may in this case be stored either in an internal memory of the data goggles or in an external memory outside the data goggles. In the latter case, the data goggles may advantageously be set up for a wired or wireless data transmission or communication link to at least one external device. In particular, the data goggles may have at least one interface that can be used to set up a connection to a local area network and/or to the Internet. By way of example, such an interface can be used to retrieve data from sensors installed in the bodies or machines, such as vibration sensors, for example, and, if required, to store them in the data goggles themselves or forward them to an external memory. Furthermore, such an interface can be used to access an order for servicing of the two bodies or machines that is stored in an external maintenance database and that is identified on the basis of the captured marking. Specifically the Internet allows relative information to be provided on the basis of context.

Advantageously, arranging the light emission apparatus and the light sensing apparatus involves the display means being used to display positions at which the light emission apparatus and the light sensing apparatus need to be arranged. By way of example, these positions can be displayed to a user using pseudo 3D images, which may be animated as far as what is known as augmented reality or virtual reality. This makes it simpler for the user to prepare the orientation, since he can immediately position the light emission apparatus and the light sensing apparatus correctly without laboriously having to try to obtain information about the correct positions thereof.

Further, it is advantageous if one or more of the captured images are taken as a basis for checking whether the light emission apparatus and the light sensing apparatus are arranged in a prescribed manner, with a result of this check being displayed in the display means. This allows any erroneous positionings of the light emission apparatus and the light sensing apparatus to be quickly rectified. For this purpose, the light emission apparatus and the light sensing apparatus may be provided, by way of example, with different colors, symbols or characters.

Advantageously, adjustment values for axes of rotation of rotatably mounted machine parts of two machines are depicted graphically in the display means in a manner in which they are overlaid on the two machines, so as thereby to expand the view of the machines. In this case, the translational and rotational offsets are depicted in exaggerated fashion in order to illustrate to the user the arithmetic signs of the respective values.

In practice, orders for servicing machines or for orienting their machine parts frequently have the locations of the relevant machines recorded in them. In order to make it easier for servicing persons to find the machines to be serviced, one preferred embodiment of the invention has provision for the display means to be used to display information about a location of the bodies and/or a direction indicator leading to the bodies. By way of example, the display means can display a factory plan in which the current locations of the servicing person and the machines to be serviced are marked. Furthermore, the display means can be used to display an arrow as a direction indicator that indicates to the servicing person that direction in which he needs to go in order to get to the machines to be serviced on the shortest or quickest route. In this connection, the data goggles may advantageously have an interface that can be used to set up a connection to a navigation system, which may be, by way of example, the GPS Global Positioning System system or a system for indoor navigation.

In one preferred embodiment, the display means is used to display a flowchart for the method. By way of example, a corresponding flowchart or a workflow for the orientation process can proceed in a similar manner during the case of a known orientation computer, and can provide the servicing person with the particular next work steps he needs to perform.

The invention is explained in more detail below with reference to a simple exemplary embodiment with reference to the accompanying drawings.

### BRIEF DESCRIPTION OF THE DRAWINGS

FIG. 1a shows two machines having rotatable machine parts, wherein a light emission apparatus and a light sensing apparatus of an orientation system are mounted on the machine parts;

FIG. 1b shows a pair of data goggles of the orientation system;

FIG. 2 shows a person wearing data goggles that have an inclinometer;

FIG. 3 shows reference lines for determining dimensions of the machines by means of the data goggles.

### DETAILED DESCRIPITON OF THE INVENTION

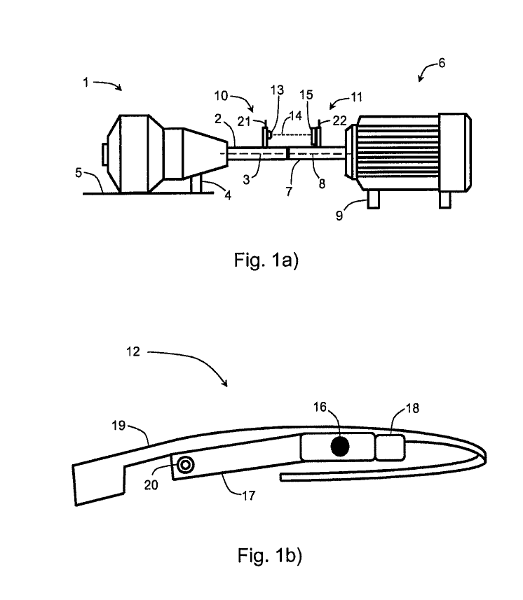

FIG. 1a depicts a machine 1 having an elongate machine part 2 with a round cross section that is mounted so as to be rotatable about the horizontally oriented longitudinal axis of said elongate machine part, so that the longitudinal axis of the machine part 2 simultaneously forms the axis of rotation 3 thereof. The machine 1 further has supporting legs 4 by means of which it is stationed on a pedestal 5, as depicted in the present case, or else can be stationed on another suitable base, such as the ground, for example. A further machine 6, which likewise has an elongate, horizontally oriented machine part 7 with a round cross section, wherein the longitudinal axis of the machine part 7 simultaneously forms the axis of rotation 8 thereof, is arranged adjacently to the machine 1 such that the two machine parts 2 and 7 have their end faces facing one another. In practice, a coupling device is usually provided between the machine parts 2 and 7, which coupling device is not shown in FIG. 1a, however, for reasons of clarity. In a similar manner to the machine 1, the machine 6 also has supporting legs 9 by means of which it is stationed on a suitable base, for example, a pedestal 5 like the machine 1, or on the ground as depicted in FIG. 1a.

Operation of the two machines 1 and 6 requires the axes of rotation 3 and 8 of their respective machine parts 2 and 7 to be oriented as precisely as possible and to be in alignment with one another. In order to orient the axes of rotation 3 and 8 of the two rotatable machine parts 2 and 7 of the machines 1 and 6 in alignment, an orientation system is provided that, in the present case, comprises a light emission apparatus 10, a light sensing apparatus 11 and a pair of data goggles 12, which are depicted in more detail in FIG. 1b.

The light emission apparatus 10 has a laser 13 that produces light or laser light in the form of a laser beam 14. Accordingly, the light sensing apparatus 11 has a light sensor having a light-sensitive area 15 for sensing the laser beam 14 produced by the light emission apparatus 10. The light-sensitive area 15 is particularly set up to register impingement positions for the laser beam 14 on the light-sensitive area 15.

Like known data goggles, the data goggles 12 of the orientation system also have a camera 16 as image capture means, a processor 17 as data processing means and a head up display or HUD 18 as display means. In this case, the HUD 18 is arranged such that it is positioned in front of one eye of a wearer of the data goggles 12. Arranged next to the HUD 18 toward the ear of the wearer of the data goggles 12 is the camera 16, while the processor 17 is situated in the adjoining leg 19. Further, an interface 20 for wireless communication is provided, which the data goggles 12 can use to communicate with the light emission apparatus 10, which has a corresponding interface 21. Furthermore, the data goggles 12 can also communicate with the light sensing apparatus 11, which for this purpose likewise has a corresponding interface 22.

So as now to orient the axes of rotation 3 and 8 of the machine parts 2 and 7 in alignment, the light emission apparatus 10 and the light sensing apparatus 11 are first of all arranged on the machine parts 2 and 7 and fixed thereto. The respective positions at which the light emission apparatus 10 and the light sensing apparatus 11 need to be arranged on the machine parts 2 and 7 are to this end displayed in the HUD 18 so that a servicing person wearing the data goggles 12 can perform arrangement of the light emission apparatus 10 and of the light sensing apparatus 11 without error and without a high level of time involvement. In this case, the light emission apparatus 10 is arranged on the machine part 2 such that a laser beam 14 that said light emission apparatus produces is emitted substantially parallel to the axis of rotation 3 of the machine part 2 of the machine 1 in the direction of the machine 6. Accordingly, the light sensing apparatus 11 is arranged on the machine part 7 of the machine 6 such that the light-sensitive area 15 of said light sensing apparatus faces the laser 13 and a laser beam 14 emitted by the laser 13 impinges on the light-sensitive area 15. To check whether the light emission apparatus 10 and the light sensing apparatus 11 have been fixed to the machine parts 2 and 7 correctly, the camera 16 can be used to record an image of the light emission apparatus 10, the light sensing apparatus 11 and the machine parts 2 and 7 and said image can be evaluated by the processor 17. The result of this evaluation is displayed to the servicing person in the HUD 18, so that he can correct the arrangement of the light emission apparatus 10 and of the light sensing apparatus 11 immediately if need be.

Although, in the present exemplary embodiment of an orientation system, the light emission apparatus 10 is arranged on the machine part 2 of the machine 1 and the light sensing apparatus 11 is arranged on the machine part 7 in the machine 6, it is also possible, in other embodiments of the orientation system, for both the light emission apparatus 10 and the light sensing apparatus 11 to be arranged on the same machine part 2 or 7 of the same machine 1 or 6. In order to ensure that laser beams 14 emitted by the laser 13 also strike the light-sensitive area 15 of the light sensing apparatus 11 in such embodiments of the orientation system, optical means, such as mirrors, lenses or prisms, for example, are provided that are at least in part arranged on that machine part 2 or 7 on which the light emission apparatus 10 and the light sensing apparatus 11 are not situated.

Following arrangement of the light emission apparatus 10 and the light sensing apparatus 11 on the machine parts 2 and 7, the camera 16 of the data goggles 12 is used to capture at least one image of the machines 1 and 6, machine parts 2 and 7 or of the light emission apparatus 10 and the light sensing apparatus 11, or at least one image of the whole arrangement consisting of the machines 1 and 6 and the light emission apparatus 10 and the light sensing apparatus 11 of the orientation system is captured. On the basis of this image or these images, the processor 17 of the data goggles 12 then determines or ascertains dimensions of the machines 1 and 6 and of the machine parts 2 and 7 that are relevant to the orientation process, and also the respective positions of said machines and machine parts relative to one another. There are various options for this, of which three preferred methods are described in more detail further below.

As soon as the necessary information about dimensions and positions of the machines 1 and 6 and of the machine parts 2 and 7 is available, the laser 13 is prompted by the processor 17, wirelessly via the interface 20 of the data goggles 12 and the interface 21 of the light emission apparatus 10, to emit a laser beam 14. The impingement position of said laser beam on the light-sensitive area 15 of the light sensing apparatus 11 is registered by the light sensing apparatus 11. The two machine parts 2 and 7 are then rotated synchronously, with the light emission apparatus 10 and the light sensing apparatus 11, which are fixed on the machine parts 2 and 7, rotating concomitantly. In this case, the machine parts 2 and 7 rotate such that the laser beam 14 always impinges on the light-sensitive area 15 throughout the rotation, or that the machine parts 2 and 7 have the same sense of rotation or the same direction of rotation in a line of vision along the axes of rotation 3 and 8. Preferably, the machine parts 2 and 7 are rotated once through 360° in this case, but in some cases a rotation of less than 360° may also be sufficient. If the axes of rotation 3 and 8 are not in alignment with one another, the impingement position of the laser beam 14 on the light-sensitive area 15 will change and describe an ellipsoidal path from which it is possible to determine the extent of the deviation of the axes of rotation 3 and 8 from the ideally oriented arrangement. Throughout the rotation, the light sensing apparatus 11 then registers the impingement positions of the laser beam 14 on the light-sensitive area 15 and generates measurement data that represent these registered impingement positions. These measurement data are transmitted to the processor 17 of the data goggles wirelessly by the light sensing apparatus 11 via the interface 22 thereof and the interface 20 of the data goggles 12, this being able to be done in real time or even after completion of the rotation of the machine parts 2 and 7. Synchrounous rotation is just one mode, pass mode could also be used. In pass mode, the machine parts need not be mechanically coupled, i.e., first a machine part with the light beam changes position, then a machine part with the light-sensitive area is moved and so on.

The processor 17 processes the received measurement data. In this case, at least one adjustment value is generated that indicates what position of which of the machines needs to be changed in what way in order to bring the two axes of rotation 3 and 8 into aligned orientation with one another. This adjustment value may be, by way of example, a translational displacement value in the horizontal or vertical direction or an angle of rotation about a prescribed axis. This adjustment value is then displayed in the HUD 18, so that a servicing person wearing the data goggles 12 can immediately change the positions of one of the machines 1 or 6 or of both machines 1 and 6 in accordance with the adjustment values. In this case, the two axes of rotation 2, 8 are graphically depicted in a manner in which they are overlaid on the two machines 1, 6 so as thereby to expand the view of the machines 1, 6. In this case, the translational and rotational offsets are depicted in exaggerated fashion in order to illustrate the arithmetic signs of the respective values to the user. The change of position can occur, for example, by virtue of suitable shims being put underneath the machines 1 and 6 or by means of a displacement mechanism that is suitable for this purpose. If necessary, the rotation of the machine parts 2 and 7 can be repeated as often as desired in order to use adjustment values obtained therefrom to repeatedly change the positions of the machines 1 and 6 as often as required for the axes of rotation 3 and 8 to be sufficiently in alignment with one another.

During performance of the whole method, the servicing person can have a flowchart displayed in the HUD 18 in order to inform the servicing person about subsequent work steps to be performed at any time.

One option for determining the dimensions of the machines 1 and 6 and of the machine parts 2 and 7 using an image captured or recorded by the camera 16 involves a reference scale being arranged on one of the machines 1 and 6 or adjacently to the machines 1 and 6, so that this reference scale appears in the image that the camera 16 records for the arrangement consisting of the machines 1 and 6 and the light emission apparatus 10 and the light sensing apparatus 11 of the orientation system. The reference scale appearing in the image means that the processor 17 can use simple ratio formation to determine real lengths from apparent lengths occurring in the image.

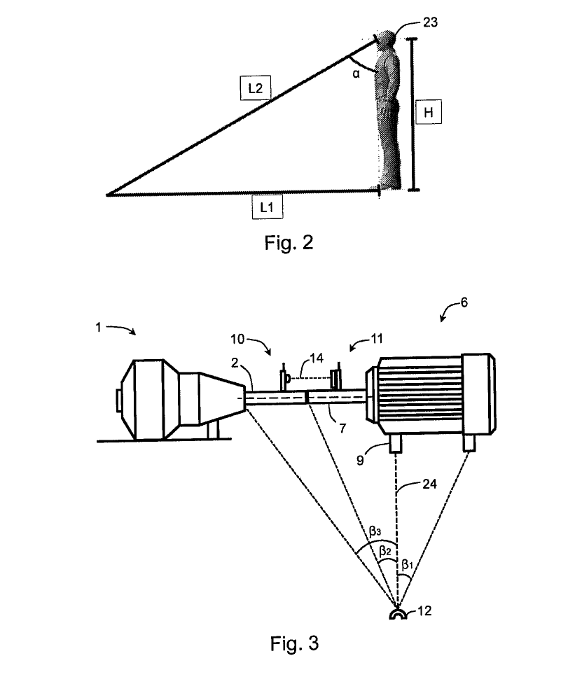

A further option for determining the dimensions of the machines 1 and 6 and of the machine parts 2 and 7 using an image captured by the camera 16 is explained in FIGS. 2 and 3. For this purpose, the data goggles 12 are equipped with a solid angle measurement means, such as an inclinometer, for example. Such data goggles 12 are worn by a person 23 in FIG. 2. As a result, the data goggles 12 are at a prescribed height H above the ground. When the person looks straight ahead with his line of vision parallel to the ground, the inclinometer measures a right angle as the angle of inclination between the line of vision and a perpendicular or normal to the ground. As soon as the person sights a point on the ground or captures it with the camera 16, as shown in FIG. 2, the angle of inclination a between his line of vision and the perpendicular to the ground decreases and is then less than 90° . Since the height H and the angle of inclination a measured by the inclinometer are known, the processor 17 is able to use trigonometric functions to determine both the horizontal distance L₁ from the person to the sighted point or captured point and the distance L₂ from the data goggles to this point in a known manner. If, furthermore, a horizontal angle or angle of azimuth with respect to the sighted point is also known, then this can be used to determine a space vector having a length and two solid angles.

To capture the angle of azimuth, FIG. 3 shows an exemplary reference line 24 from the data goggles 12 to one of the supporting legs 9 of the machine 6. Further, FIG. 3 shows lines of vision to various prominent points on the machines 1 and 6 and the machine parts 2 and 7 thereof, which respectively have different angles of azimuth β with respect to the reference line 24. By measuring the angles of azimuth and angles of inclination with respect to particular points, it is therefore possible to determine respective space vectors and, from these, in turn distances between individual points. To determine the dimensions of the machines 1 and 6 and the machine parts 2 and 7 thereof, it therefore suffices to sight relevant points on the machines 1 and 6 and machine parts 2 and 7 with the data goggles 12, or to capture them with the camera 16, so that the data goggles 12 can use the solid angle measurement means to measure the angles of azimuth and angles of inclination for these points and, when the position of the data goggles 12 is known, the processor 17 can determine the sought dimensions.

A particularly simple variant for determining the dimensions of the machines 1 and 6 and of the machine parts 2 and 7 using an image captured with the camera 16 involves putting respective markings on the machines 1 and 6 that clearly denote the respective machine 1 or 6. When the processor 17 evaluates an image recorded by the camera 16 in which one of these markings appears, it is able to recognize the marking and clearly identify the associated machine 1 or 6. Therefore, it is possible to access a database that stores the dimensions of the relevant machine 1 or 6. This database may be situated either in a memory of the data goggles 12, in a supplementary module of the orientation system or else in an external memory system. If the database is situated in a supplementary module of the orientation system, then the data goggles 12 can have an option for the wireless or wired data transmission or communication link to this database in order to be able to access the data stored thereon. If the database is provided in an external memory system, then the data goggles 12 can have, for the purpose of accessing the database, an appropriate interface to a network that connects the data goggles 12 to the memory system, for example, an LAN Local Area Network, an intranet or the Internet. The interface 20 described above, in particular, may be set up for all of these purposes.

A further option for use of the orientation system comprising the light emission apparatus 10, the light sensing apparatus 11 and the data goggles 12 involves the permanent monitoring of the positioning of two machines arranged at prescribed positions relative to one another during the operation of said machines. To this end, the light emission apparatus 10 is arranged on one of the two machines and the light sensing apparatus 11 is arranged on the respective other of the two machines, so that the laser beam 14 emitted by the light emission apparatus 10 impinges on the light-sensitive area 15 of the light sensing apparatus 11. If the position of the two machines relative to one another changes as a result of vibrations that occur during machine operation, then the impingement position of the laser beam 14 on the light-sensitive area 15 of the light sensing apparatus 11 changes accordingly, and consequently so does the adjustment value ascertained by the data goggles 12 in the manner described. For the adjustment value, a limit value can be prescribed that, when exceeded by the adjustment value, means that the deviation of the relative positions of the two machines from the prescribed positions thereof has exceeded a critical value. In this case, an appropriate signal can be output either in the head up display 18 of the data goggles 12 or in another way, for example, via a loudspeaker, in order to indicate to the user that the machines need to be stopped and the positions thereof readjusted, for which purpose the adjustment value can be used. In this way, it is possible for the relative positions of the machines to be monitored in real time during the operation thereof.

1-12. (canceled).

13. A method for bringing two bodies into prescribed positions relative to one another, comprising the steps of:
a) arranging at least one light emission apparatus of an orientation system on one of the bodies and at least one light sensing apparatus of the orientation system on another of the bodies;
b) capturing at least one image of at least parts of the bodies using an image capture means of a pair of data goggles of the orientation system;
c) using a data processing means of the data goggles for determining at least one dimensions of the bodies and respective positions of the bodies relative to one another based on the at least one image captured;
d) registering impingement positions of a light beam emitted by the light emission apparatus on a light-sensitive area of the light sensing apparatus ;
e) transmitting measurement data representing the registered impingement positions to the data goggles ;
f) using the data processing means for processing the measurement data and for producing at least one adjustment value that indicates how the positions of the bodies need to be changed to reach the prescribed positions relative to one another;
g) displaying the at least one adjustment value on a display means of the data goggles;
h) changing the positions of the bodies in accordance with the at least one adjustment value.

14. The method as claimed in claim 13, in which the bodies are rotatably mounted machine parts of two machines that have respective axes of rotation, and said changing of the positions brings the machine parts into positions relative to one another in which the axes of rotation are in alignment with one another, and wherein the machine parts are rotated during said registering of the impingement positions of the light beam on the light-sensitive area.

15. The method as claimed in claim 13, in which the bodies are machines and wherein at least steps d) to g) are carried out during operation of the machines.

16. The method as claimed in claim 13, in which step b) is preceded by at least one reference scale being arranged on or adjacent to one of the bodies at a location that will appear in the at least one image captured in step b), wherein at least one of the dimensions of the bodies and the respective positions of the bodies relative to one another are determined by a comparison of dimensions in the image with the reference scale appearing in the image in step c).

17. The method as claimed in claim 16, wherein, in step b), the image capture means captures at least two reference points on the bodies from a prescribed physical position, a solid angle measurement means of the data goggles measuring respective angles between a reference line and respective connecting lines that connect the respective reference points to the prescribed physical position, and wherein the measured angles are used in step c) for determining said at least one of the dimensions of the bodies and the respective positions of the bodies relative to one another.

18. The method as claimed in claim 13, in which the image capture means captures an image of at least one marking on one of the bodies and wherein the at least one marking is used as a basis for the data goggles to access stored data.

19. The method as claimed in claim 13, wherein, in step a), the display means displays positions at which the light emission apparatus and the light sensing apparatus need to be arranged.

20. The method as claimed in claim 13, in which one or more images captured in step b) are used as a basis for checking whether the light emission apparatus and the light sensing apparatus are arranged in a prescribed manner, and wherein a result of the checking is displayed in the display means .

21. The method as claimed in claim 13, wherein the display means displays information about at least one of a location of the bodies and a direction indicator leading to the bodies .

22. The method as claimed in claim 13, wherein the display means displays a flowchart for performance the method.

23. An orientation system for bringing two bodies into prescribed positions relative to one another, comprising:
at least one light emission apparatus for emitting a light beam that is mountable on one of the two bodies,
at least one light sensing apparatus that has a light-sensitive area that is mountable on the other of the two bodies and on which an impingement position of a light beam emitted by the light emission apparatus on the light-sensitive area is registrable, and
at least one pair of data goggles comprised of a data transmission link by which the data goggles are connectable to the light sensing apparatus, at least one image capture means for capturing at least one image of at least parts of the bodies, at least one data processing means for determining at least one of dimensions of the bodies and respective positions of the bodies relative to one another based on the at least one image captured, the data processing means being adapted for processing the measurement data and for producing at least one adjustment value that indicates how the positions of the bodies need to be changed to reach prescribed positions relative to one another, and at least one display means for displaying the at least one adjustment value.

24. The orientation system as claimed in claim 23, the data goggles further comprising at least one of at least one solid angle measurement means, at least one inclinometer and at least one interface for setting up a connection to at least one of a local area network, the Internet and a navigation system.
